(19) United States
(12) Patent Application Publication
(10) Pub. No.: US 2007/0239531 A1
(43) Pub. Date: Oct. 11, 2007

(54) Controlling the serving of serially rendered ads, such as audio ads

(76) Inventors: Francoise Beaufays, Mountain View, CA (US); William J. Byrne, Davis, CA (US); Brian Strope, Palo Alto, CA (US)

Correspondence Address: STRAUB & POKOTYLO, 620 TINTON AVENUE, BLDG. B, 2ND FLOOR, TINTON FALLS, NJ, 07724, US

(21) Appl. No.: 11/394,143

(22) Filed: Mar. 30, 2006

(51) Int. Cl. G06Q 30/00

(52) U.S. Cl. 705/14

(57) ABSTRACT

A request for listing information is received, and if the request is determined to be for an unspecific listing, a number of ads are served prior to delivery of the requested listings. If the request is determined to not be for an unspecific business, a lesser number (or zero) ads are served prior to delivery of the requested listings. The determination of the request as being unspecific can be made by comparing the request to a list of unspecific requests, determining if the request exactly matches a listing, or by other means. Ads served result in the advertiser being assessed a per-impression charge.

### BACKGROUND OF THE INVENTION

1. Field of the Invention

The present invention concerns advertising, such as online advertising for example. In particular, the present invention concerns decisions related to serving serially rendered ads, such as audio ads.

2. Background Information

Advertising using traditional media, such as television, radio, newspapers and magazines, is well known. Unfortunately, even when armed with demographic studies and entirely reasonable assumptions about the typical audience of various media outlets, advertisers recognize that much of their ad budget is simply wasted. Moreover, it is very difficult to identify and eliminate such waste.

Recently, advertising over more interactive media has become popular. For example, as the number of people using the Internet has exploded, advertisers have come to appreciate media and services offered over the Internet as a potentially powerful way to advertise.

Interactive advertising provides opportunities for advertisers to target their ads to a receptive audience. That is, targeted ads are more likely to be useful to end users since the ads may be relevant to a need inferred from some user activity (e.g., relevant to a user's search query to a search engine, relevant to content in a document requested by the user, etc.). Query keyword targeting has been used by search engines to deliver relevant ads. For example, the AdWords advertising system by Google Inc. of Mountain View, Calif. (referred to as “Google”), delivers ads targeted to keywords from search queries. Similarly, content targeted ad delivery systems have been proposed. For example, U.S. patent application Ser. No. 10/314,427 (incorporated herein, in its entirety, by reference and referred to as “the '427 application”), titled “METHODS AND APPARATUS FOR SERVING RELEVANT ADVERTISEMENTS”, filed on Dec. 6, 2002 and listing Jeffrey A. Dean, Georges R. Harik and Paul Buchheit as inventors; and Ser. No. 10/375,900 (incorporated herein, in its entirety, by reference and referred to as “the '900 application”), titled “SERVING ADVERTISEMENTS BASED ON CONTENT,” filed on Feb. 26, 2003 and listing Darrell Anderson, Paul Buchheit, Alex Carobus, Claire Cui, Jeffrey A. Dean, Georges R. Harik, Deepak Jindal and Narayanan Shivakumar as inventors, describe methods and apparatus for serving ads relevant to the content of a document, such as a Web page for example. Content targeted ad delivery systems, such as the AdSense advertising system by Google for example, have been used to serve ads on Web pages.

As can be appreciated from the foregoing, serving ads relevant to concepts of text in a text document and serving ads relevant to keywords in a search query are useful because such ads presumably concern a current user interest.

In certain situations, great care should be taken to ensure that only very relevant ads are rendered to a user. Consider, for example, a voice interface to local search that lets people easily find businesses when they're not at a computer. Given their serial and temporal nature, playing ads on a voice channel might be annoying because doing so might force the user to wait—they may be slow and harder for the caller to ignore. Over time bad, irrelevant, and/or annoying ads can deteriorate the potential value of other ads by reducing the repeat caller's expectation of value when ads are played. Conversely, consistently relevant ads reinforce the caller's expectation of value, thereby increasing the potential value of other ads. Therefore, it would be useful to condition the serving of potentially annoying ads, such as audio ads and other serially rendered ads. It would also be useful for the ads to be presented to users in such a manner that they can distinguish commercial ads from unbiased search results.

### SUMMARY OF THE INVENTION

In a Web search, a user may tolerate tens or even hundreds of ads that never get clicked on. Since the user can quickly skip over or ignore such ads, there is a wide range of potentially relevant ads that are tolerable to the user even if they are not extremely useful. With an audio interface, skipping over serial items such as audio ads is more cumbersome (or, in some cases, impossible), so ads should only be inserted when there is a high likelihood of potential user interest (e.g., relevance). For instance, a user might be annoyed if presented an ad when a specific listing has been requested, but may be more receptive to a relevant ad when the user has made a generic (unspecific) request for information. This controllable or conditional ad serving may result in a lower frequency of served ads together with a higher expected success rate for those ads, which makes the process ideal in environments where information is presented to users serially.

Embodiments consistent with the present invention may be used to receive a user request for listing information, and if the request is determined to be for an unspecific listing (such as a generic business category request), a first number of one or more serial ads may be served before (or instead of) the delivery of the search results (or “listings”) to the user (client) device that made the request. If, on the other hand, the request is determined to not be for an unspecific business, a lesser number (e.g., zero) of serial ads may be served before the delivery of the listings.

When ads are played, they may be clearly marked as ads with an initial phrase (e.g. “Sponsored Link”) to help train the caller's expectation for the value of the ad, and to help the user distinguish the ad from an “unbiased” search result.

Determining whether the request is unspecific or not can be made using a number of different techniques. For example, at least some embodiments consistent with the present invention may compare the user request to a pre-existing list of unspecific requests. If the request matches an item on the list, the request is probably unspecific. In other embodiments, a determination could be made as to whether the user request exactly matches a listing. If so, the user request is probably specific. In still other embodiments, the number and/or diversity of the listings found in response to the user request can be used in the determination. For instance, if there is a large, diverse body of listings found, the request is probably unspecific. Further, the judgment as to whether the request is unspecific can be influenced by the geographic locale of the requested listings. Thus, it should be understood that many other possible methods of determining whether a request is unspecific may be employed, consistent with the present invention. For example, one or more of the foregoing techniques might be combined in a manner to provide a better or an optimized determination.

In some embodiments consistent with the present invention, ads served might result in the advertiser being assessed a per-impression charge. Alternatively, or in addition, if the user signals that he or she wishes to be connected (e.g., via telephone) to the advertiser of the ad, a per-conversion charge could be assessed against the advertiser.

### BRIEF DESCRIPTION OF THE DRAWINGS

FIG. 1 is a diagram illustrating an environment in which, or with which, embodiments consistent with the present invention may operate.

FIG. 2 is a flow diagram of an exemplary method for serving ads in a manner consistent with the present invention.

FIG. 3 is a flow diagram of an exemplary method for determining whether or not a request is unspecific in a manner consistent with the present invention.

FIG. 4 is a block diagram of apparatus that may be used to perform at least some operations, and store at least some information, in a manner consistent with the present invention.

### DETAILED DESCRIPTION

The present invention may involve novel methods, apparatus, message formats, and/or data structures for improving the serving of serially rendered ads, such as audio ads. The following description is presented to enable one skilled in the art to make and use the invention, and is provided in the context of particular applications and their requirements. Thus, the following description of embodiments consistent with the present invention provides illustration and description, but is not intended to be exhaustive or to limit the present invention to the precise form disclosed. Various modifications to the disclosed embodiments will be apparent to those skilled in the art, and the general principles set forth below may be applied to other embodiments and applications. For example, although a series of acts may be described with reference to a flow diagram, the order of acts may differ in other implementations when the performance of one act is not dependent on the completion of another act. Further, non-dependent acts may be performed in parallel. Also, as used herein, the article “a” is intended to include one or more items. Where only one item is intended, the term “one” or similar language is used. In the following, “information” may refer to the actual information, or a pointer to, identifier of, or location of such information. No element, act or instruction used in the description should be construed as critical or essential to the present invention unless explicitly described as such. Thus, the present invention is not intended to be limited to the embodiments shown and the inventor regards his invention to include any patentable subject matter described.

In the following definitions of terms that may be used in the specification are provided in §4.1. Then, environments in which, or with which, the present invention may operate are described in §4.2. Exemplary embodiments of the present invention are described in §4.3. Thereafter, specific examples illustrating the utility of exemplary embodiments of the present invention are provided in §4.4. Finally, some conclusions regarding the present invention are set forth in §4.5.

### Definitions

Ads may have various intrinsic features. Such features may be specified by an application and/or an advertiser. These features are referred to as “ad features” below. For example, in the case of a text ad, ad features may include a title line, ad text, and an embedded link. In the case of an image ad, ad features may include images, executable code, and an embedded link. In the case of an audio and/or video ad, ad features may include audio and/or video content. The ad features may also include executable code (e.g., encoded as tones, pixels, etc., provided in non-video packets of a video stream, etc.). Depending on the type of online ad, ad features may include one or more of the following: text, a link, an audio file, a video file, an image file, executable code, embedded information, a callable telephone number, etc. In devices that can render more than one type of media (devices that have different outputs), some ad features may pertain to one type of media rendered to the user over one output, while other ad features may pertain to another type of media rendered to the user over another output. For example, if a mobile telephone includes a speaker, a display and telephony means, a video ad to be rendered on such a telephone can have one or more of an audio-video component and executable code for dialing an encoded telephone number. Naturally, other types of ad features are possible.

When an online ad (e.g., an audio ad, a video ad, etc.) is served, one or more parameters may be used to describe how, when, and/or where the ad was served. These parameters are referred to as “serving parameters” below. Serving parameters may include, for example, one or more of the following: features of (including information on) a document on which, or with which, the ad was served, a search query or search results associated with the serving of the ad, a user characteristic (e.g., their geographic location, the language used by the user, the type of browser used, previous page views, previous behavior, user account, any Web cookies used by the system, user device characteristics, etc.), a host or affiliate site (e.g., America Online, Google, Yahoo) that initiated the request, an absolute position of the ad on the page on which it was served, an ad spot in which the ad was served (e.g., a position (spatial or temporal) of the ad relative to other ads served), an absolute size of the ad, a size of the ad relative to other ads, an absolute and/or relative resolution of the ad, an absolute and/or relative video frame rate of the ad, an absolute volume of the ad, a volume of the ad relative to other ads, an absolute temporal length of the ad, a temporal length of the ad relative to other ads, a color of the ad, a number of other ads served, types of other ads served, time of day served, time of week served, time of year served, etc. Naturally, there are other serving parameters that may be used in the context of the invention.

Although serving parameters may be extrinsic to ad features, they may be associated with an ad as serving conditions or constraints. When used as serving conditions or constraints, such serving parameters are referred to simply as “serving constraints” (or “targeting criteria”). For example, in some systems, an advertiser may be able to target the serving of its ad by specifying that it is only to be served on weekdays, no lower than a certain position, only to users in a certain location, etc. As another example, in some systems, an advertiser may specify that its ad is to be served only if a page or search query includes certain keywords or phrases. As yet another example, in some systems, an advertiser may specify that its ad is to be served only if a document on which, or with which, the ad is to be served, includes certain topics or concepts, or falls under a particular cluster or clusters, or some other classification or classifications (e.g., verticals). In some systems, an advertiser may specify that its ad is to be served only to (or is not to be served to) user devices having certain characteristics. Finally, in some systems, an ad might be targeted so that it is served in response to a request sourced from a particular location, or in response to a request concerning a particular location.

“Ad information” may include any combination of ad features, ad serving constraints, information derivable from ad features or ad serving constraints (referred to as “ad derived information”), and/or information related to the ad (referred to as “ad related information”), as well as an extension of such information (e.g., information derived from ad related information).

The ratio of the number of selections (e.g., clickthroughs, dial-throughs, etc.) of an ad to the number of impressions of the ad (i.e., the number of times an ad is rendered) is defined as the “selection rate” (or “clickthrough rate” or “CTR”) of the ad.

A “conversion” is said to occur when a user consummates a transaction related to a previously served ad. What constitutes a conversion may vary from case to case and can be determined in a variety of ways. For example, it may be the case that a conversion occurs when a user clicks on an ad, is referred to the advertiser's Web page, and consummates a purchase there before leaving that Web page. Alternatively, a conversion may be defined as a user being shown an ad, and making a purchase on the advertiser's Web page within a predetermined time (e.g., seven days). In yet another alternative, a conversion may be defined by an advertiser to be any measurable/observable user action such as, for example, downloading a white paper, navigating to at least a given depth of a Website, viewing at least a certain number of Web pages, spending at least a predetermined amount of time on a Website or Web page, registering on a Website, dialing a telephone number, sending a product or service inquiry, requesting a telephone connection, etc. Often, if user actions don't indicate a consummated purchase, they may indicate a sales lead, although user actions constituting a conversion are not limited to this. Indeed, many other definitions of what constitutes a conversion are possible.

The ratio of the number of conversions to the number of impressions of the ad (i.e., the number of times an ad is rendered) and the ratio of the number of conversions to the number of selections (or the number of some other earlier event) are both referred to as the “conversion rate” or “CR.” The type of conversion rate will be apparent from the context in which it is used. If a conversion is defined to be able to occur within a predetermined time since the serving of an ad, one possible definition of the conversion rate might only consider ads that have been served more than the predetermined time in the past.

A “document” is to be broadly interpreted to include any machine-readable, and/or machine-storable work product. A document may be a file, a combination of files, one or more files with embedded links to other files, etc. The files may be of any type, such as text, audio, image, video, etc. Parts of a document to be rendered to an end user can be thought of as “content” of the document. A document may include “structured data” containing both content (words, pictures, sound, conversations, etc.) and some indication of the meaning of that content (for example, e-mail fields and associated data, HTML tags and associated data, embedded program title and related information, etc.)

“Document information” may include any information included in the document, information derivable from information included in the document (referred to as “document derived information”), and/or information related to the document (referred to as “document related information”), as well as an extensions of such information (e.g., information derived from related information). An example of document derived information is a classification based on textual transcript, or audio/video content of a document. Examples of document related information include document information from other documents with links to the instant document, as well as document information from other documents to which the instant document links.

Content from a document may be rendered on a “content rendering application or device”. Examples of content rendering applications include an Internet browser (e.g., Explorer, Netscape, Opera, Firefox, etc.), a media player (e.g., an MP3 player, a streaming media file player from Microsoft Corporation of Redmond, Wash., or from RealNetworks, Inc., of Seattle, Wash., Apple Computer Inc. of Cupertino, Calif., Macromedia Inc. of San Francisco, Calif., etc.), a viewer (e.g., an Abobe Acrobat pdf reader), etc. Examples of content rendering devices include video games (e.g., Sony Play Station II and PSP, Microsoft X-Box, Nintendo GameCube, etc.), mobile telephones, televisions, radios, set-top boxes (STBs), etc.

A “content owner” is a person or entity that has some property right in the content of a media property (e.g., document). A content owner may be an author of the content. In addition, or alternatively, a content owner may have rights to reproduce the content, rights to prepare derivative works of the content, rights to display or perform the content publicly, and/or other proscribed rights in the content. Although a content server might be a content owner in the content of the documents it serves, this is not necessary. A “Web publisher” is an example of a content owner.

“User information” may include user behavior information and/or user profile information.

### Exemplary Advertising Environments in which, or with which, Embodiments Consistent with the Present Invention may Operate

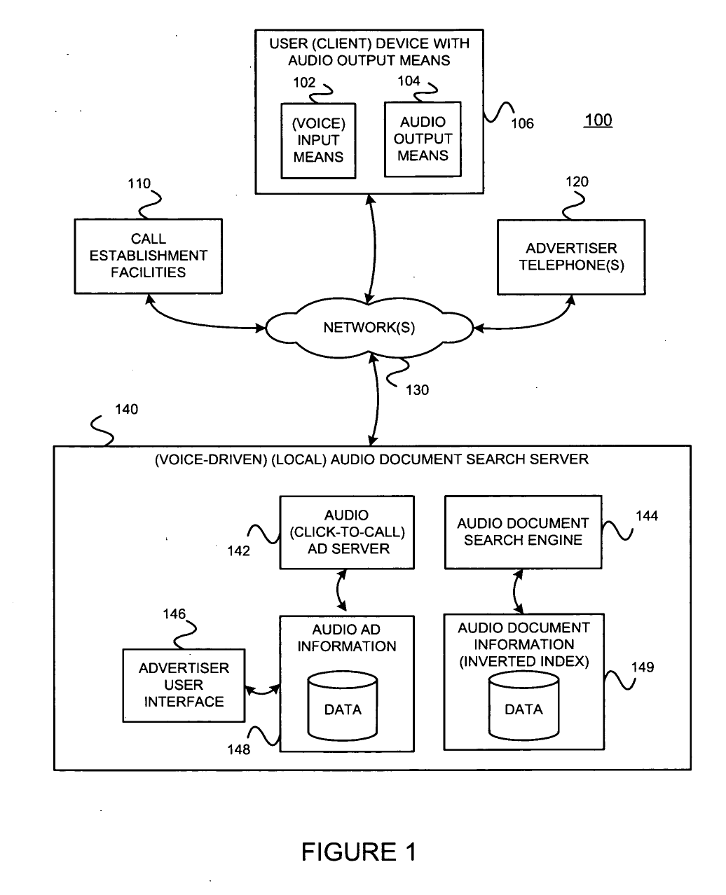

FIG. 1 illustrates an environment 100 in which, or with which, embodiments consistent with the present invention may be used. The environment 100 might include one or more user (client) devices 106, one or more call establishment facilities 110, one or more advertiser telephones 120, one or more audio document search servers 140 and one or more network(s) 130.

The user (client) device 106 contains (e.g., voice) input means 102 and audio output means 104, enabling a user to audibly communicate with other devices. The input means 102 may be any input means, but preferably includes a voice input means such as a microphone. The audio output means 104 might be, for example, a speaker or a connector for a speaker or earphone. Although not shown, the user (client) device 106 may include telephone functions. Thus, the user device 106 may be a mobile telephone for example.

Audio document search server 140 includes audio (e.g., click-to-call) ad server 142, advertiser user interface 146, audio ad information 148, audio document search engine 144 and audio document information (e.g., inverted index) 149. Advertiser user interface 146 could be used by advertisers to manage audio ads. For example, an advertiser could input, change and/or delete audio ad creatives, offer information, ad targeting information, etc., in audio ad information 148.

Call establishment facilities 110 may be used to establish a telephone call between two or more devices via network(s) 130. For example, the call establishment facilities 110 may be used to establish a telephone call between a user (client) device 106 and an advertiser telephone 120.

The network(s) 130 might include a telephone network, the Internet, a cellular network, private network, or any other communications network. The network(s) should be capable of carrying audio information. The network(s) should include at least one network having performance standards (e.g., latency, jitter, dropped calls, audio quality, etc.) at least comparable to existing telephone networks.

User (client) device 106 could contact audio document search server 140 via network(s) 130 in order to request audio document information (e.g., a business telephone listing). The (voice-driven) (local) audio document search server 140 might determine a location associated with the request (e.g., pizza in Dayton, Ohio). The audio document search server 140 may also determine if the request is specific or unspecific. This determination may be used in determining a mix of audio ads and/or audio documents to return to the requesting user (client) device 106. Audio document search engine may access audio document information (inverted index) data storage 149 in order to retrieve one or more audio documents (e.g., listings, each including a business name, address, and telephone number, etc.) responsive to a request. Audio ad server 142 may access audio ad information in order to retrieve one or more audio ads responsive to a request. The audio document search server may interact with the user of user (client)device 106, such as asking the user for additional search information, clarification, etc. Audio ad performance (e.g., selection rate, conversion rate, etc.) may be tracked. Advertiser account information (e.g., budget, time period, assessed charges, etc.) may be maintained.

### Exemplary Embodiments

Still referring to the environment of FIG. 1, audio (click-to-call) ad server 142 may determine whether a received request is for a specific business establishment. This can be done in a number of ways. Consider, for example, a query request “pizza”. One technique would be to look up the name “pizza” in a list of unspecific requests. If pizza is found in the list, the request might be categorized as “unspecific”. Alternatively, audio ad server 142 could analyze the number of business names retrieved by search engine 144, and if the number exceeded a pre-determined level (such as “1”), the request would be classified as “unspecific”. Another approach would be to see whether any retrieved business names exactly matched the request. In the case of the query “pizza”, retrieved names might include “Pizza Hut”, “Dominoes Pizza”, “John's Best Pizza”, etc. Since none of those names exactly matches the request “pizza”, the request could be deemed “unspecific”. Other methods of determining whether the request is “unspecific” could also be employed. For example, trademark database searches could be used to check for terms (e.g., words or phrases) for which trademark applications have be filed, or for which trademarks have been registered. The existence of a trademark strongly suggests that a term is specific.

If the request is deemed to be unspecific, audio ad server 142 could identify ads related to the request “pizza” using audio ad information data store 148. This could be accomplished by determining ads including, or targeted to, “pizza”. The sponsored ad(s) could then be delivered to the requesting user (client) device 106 to be played. Alternatively, a listing of business sponsors of ads could be compared with the business names retrieved from audio document information 149, and any matches could indicate ads to be served (audibly) to the requesting user (client) device 106. Other methods of selecting ads to be served based on particular unspecific information requests could be employed.

### Exemplary Methods and Data Structures

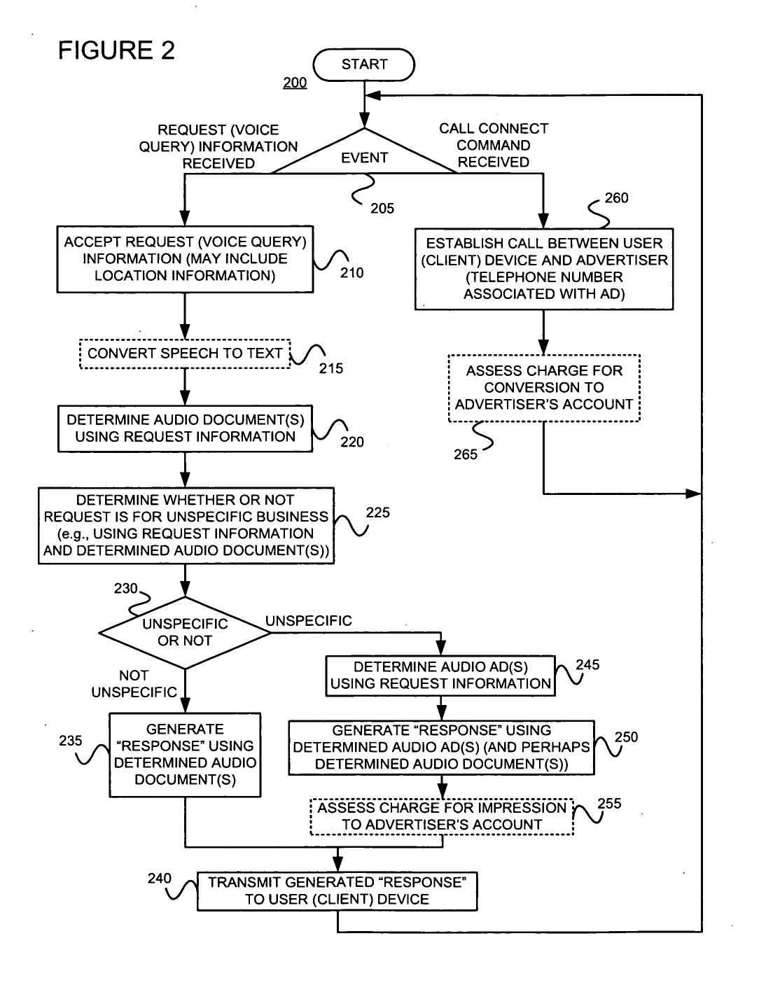

FIG. 2 is a flow diagram of an exemplary method 200 for controlling the serving audio ads in a manner consistent with the present invention. As indicated by event block 205, various branches of the method 200 may be performed in response to the occurrence of various events. For example, if request (voice query) information is received, the request information is accepted. (Block 210) The request might be, for example, a request for a specific business of for a type of business at a particular geographic location. If the request information is audio speech, the request could be converted from speech to text (e.g., using known voice recognition techniques). (Block 215) Audio documents (such as the name, address, phone number, etc.) of businesses may be determined using the (e.g., converted) request information. (Block 220) This could be accomplished by finding a business name that exactly matches the request (e.g., “Pizza Hut”), or a part of which matches the request (e.g., request for “pizza” could result in a partial match of “Pizza Hut”). Alternatively, a listing of types of businesses could include a category called “pizza”, and the businesses in that category could be identified. It is determined whether or not the request is for an unspecific business. (Block 225) This may be done in various ways as described later.

If the request is determined to be “specific” (or not unspecific), a “responsive message” may be generated using the determined audio document(s) (each such document containing items such as name, address, and telephone numbers). (Blocks 230 and 235) The generated response may then be transmitted to the requesting user (client) device (Block 240) before the method 200 branches back to event block 205.

Referring back to block 230, if the request is determined to be “unspecific”, then one or more audio ads may be determined using the request information (Block 245) and a responsive message may be generated using the determined ad(s) (and perhaps the determined audio document(s)). (Block 250) The generated response may then be transmitted to the user (client) device (Block 240) before the method 200 branches back to event block 205. A charge for an ad impression might be assessed to the advertiser's account. (Block 255)

Referring back to event block 205, if a call connect command (e.g., due to a user click-to-call action) is received (e.g., from a user device), a call between the requesting user (client) device and the advertiser (if in response to an ad) or an owner of a listing (if a search result audio document) is established. (Block 260) If the user call connection command is in response to an ad (sponsored link), an ad conversion charge might be assessed to the advertiser's account. (Block 265)

Referring back to block 225, embodiments consistent with the present invention might estimate whether the request is likely to be a generic request or for a specific listing. This is more obvious for “Pizza Hut” (specific) and “pizza” (generic). However, consider the request “carpaccios”. The user could intend (a) a restaurant named “Carpaccios” or (b) more generally, restaurants that serve carpaccio. At least some embodiments consistent with the present invention might determine whether or not a request is unspecific by determining whether the request matches a database of predefined unspecific categories, and/or matches a listing of specific businesses.

In at least some embodiments consistent with the present invention, the exact definition of what's specific versus general might be learned from user preferences, which in general may be location specific. For example, “corner diner” queries might be a specific request in Lincoln, Nebr. but a generic request in New York City.

Another approach might be to determine if any specific business/government/residence listings exactly match the request. If so, the request might be classified as “specific”. Alternatively, if no listings exactly match the request, but the request was recognized as a category of businesses (e.g., pizza sellers), if any of the selected results within that category were also sponsored ads (or if an ad sponsor identified the category as a trigger to serving their ad) then the ad(s) might be served before (or instead of) the other search results. In at least some embodiments consistent with the present invention, the likelihood that a request is unspecific might be estimated using the diversity of the selected results given the query.

The likelihood that a request is unspecific may also be estimated using entropy-based metrics that consider the variance of callers' selections after a given query, where a high variance of callers' selections to the same query may indicate a higher likelihood of a non-specific request.

Alternatively, databases or lists of business categories may be used as a source of evidence that a given query corresponds to an unspecific listing. Databases that maintain business names that have become generic (e.g. “a kleenex”) can also be used as sources of unspecific listings.

In some embodiments consistent with the present invention, the query may be an audio signal transcribed by a speech recognition system. In this case, an estimate of a confidence level the speech recognition result (confidence score) may be used to decide when ads should be served (e.g. More generic ads or no ad) can be served when the confidence score is low.

To reduce the ability of companies to buy competitor's names to try to get their sponsored links ahead of the caller's explicit request, bids for words or phrases might be first checked against the business listing database for the location where the ad is intending to be served. For example, if there's a specific listing for “corner drug store” in Lincoln, Nebr., then that phrase might be made unavailable for other companies' sponsored links there, even if the automatic category estimation means determines that there is sufficient evidence that “corner drug store” usually means an unspecific business type. This also keeps Burger King from buying ads for requests of McDonalds, even if there happened to be a wide diversity of listings actually chosen when callers first request McDonalds.

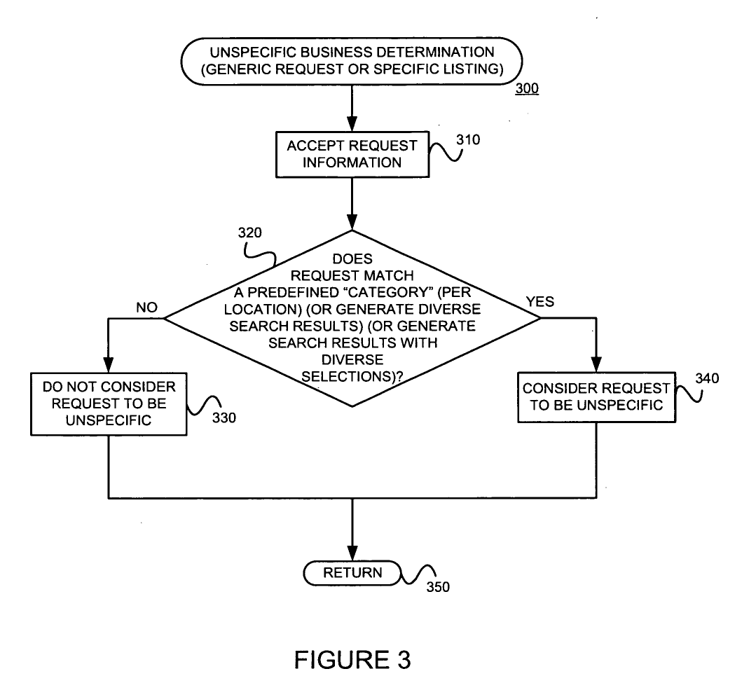

FIG. 3 is a flow diagram of an exemplary method 300 for determining whether or not a request is unspecific in a manner consistent with the present invention.

The request information is accepted. (Block 310) Whether the request matches a predefined “category” (with or without an associated geographic location) may be determined. (Block 320) If not, the request is determined to be specific (or not unspecific) (Block 330) before the method 300 is left (node 350). If yes, the request is determined to be unspecific (Block 340) before the method 300 is left (node 350).

Referring back to block 320, various indicia of the request in relation to the search results could be identified and then grouped and/or weighted in various ways. As described above, the indicia might include one or more of whether the search results are diverse, whether the number of search results exceeds a predetermined number, whether the search results exactly match the request, whether there is a diversity of selections made by other users for the same request historically, weighted combinations of these indicators that are optimized over large numbers of exemplars, etc.

Advertisers who bid for query keyword targeting terms (e.g., words or phrases) determined to be specific (e.g., business name specific) might be informed that (A) they cannot bid on such phrases, (B) such phrases are regionally limited, and/or (C) their ad might be served only after more specific listing are served, due to the specific nature of the query.

### Exemplary Apparatus

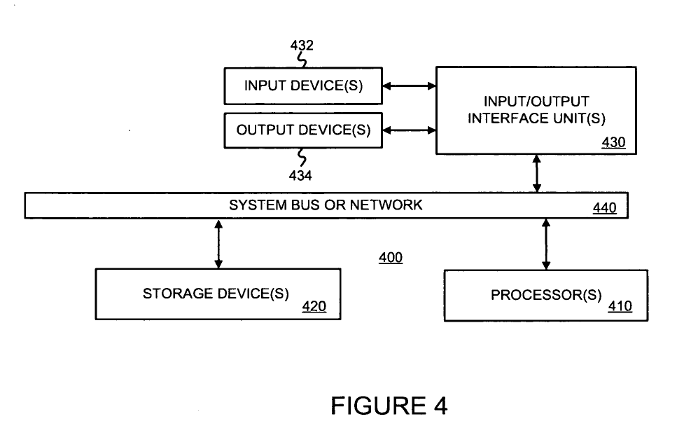

FIG. 4 is a block diagram of apparatus 400 that may be used to perform at least some operations, and store at least some information, in a manner consistent with the present invention. The apparatus 400 basically includes one or more processors 410, one or more input/output interface units 430, one or more storage devices 420, and one or more system buses and/or networks 440 for facilitating the communication of information among the coupled elements. One or more input devices 432 and one or more output devices 434 may be coupled with the one or more input/output interfaces 430.

The one or more processors 410 may execute machine-executable instructions (e.g., C or C++ running on the Solaris operating system available from Sun Microsystems Inc. of Palo Alto, Calif. or the Linux operating system widely available from a number of vendors such as Red Hat, Inc. of Durham, N.C.) to perform one or more aspects of the present invention. At least a portion of the machine executable instructions may be stored (temporarily or more permanently) on the one or more storage devices 420 and/or may be received from an external source via one or more input interface units 430.

In one embodiment, the machine 400 may be one or more conventional personal computers. In this case, the processing units 410 may be one or more microprocessors. The bus 440 may include a system bus. The storage devices 420 may include system memory, such as read only memory (ROM) and/or random access memory (RAM). The storage devices 420 may also include a hard disk drive for reading from and writing to a hard disk, a magnetic disk drive for reading from or writing to a (e.g., removable) magnetic disk, and an optical disk drive for reading from or writing to a removable (magneto-) optical disk such as a compact disk or other (magneto-) optical media.

A user may enter commands and information into the personal computer through input devices 432, such as a keyboard and pointing device (e.g., a mouse) for example. Other input devices such as a microphone, a joystick, a game pad, a satellite dish, a scanner, or the like, may also (or alternatively) be included. These and other input devices are often connected to the processing unit(s) 410 through an appropriate interface 430 coupled to the system bus 440. The output devices 434 may include a monitor or other type of display device, which may also be connected to the system bus 440 via an appropriate interface. In addition to (or instead of) the monitor, the personal computer may include other (peripheral) output devices (not shown), such as speakers and printers for example.

Referring back to FIG. 1, one or more machines 400 may be used as end user client devices, networks, advertiser telephones, call establishment facilities, and audio document search servers.

### Refinements and Alternatives

As described above, exemplary techniques consistent with the present invention may determine a request to be “specific” if the request matches the search results exactly. However, an alternative technique consistent with the present invention might perform a secondary search to see if any of the “exact matches” are associated with sponsored links. If so, the sponsored link search results could be transmitted to the user before (or instead of) the non-sponsored results. For example, if someone requested fast food in Lincoln, and there were five listings (e.g., and all are equally relevant), and one of the five was a sponsored listing (e.g., McDonalds), that listing could be provided first to the requestor, perhaps being identified as a “sponsored link”. Even for an unspecific request, an ad or a sponsored link may be one that is presented before other listings. Such other listings might be equally relevant, or even more relevant, than the sponsored link. If none of the results were associated with sponsored links, then the selected results could be delivered to the requestor alphabetically, randomly, based on listing selection rates, based on listing conversion rates, based on proximity to user (client device) location, etc.

Embodiments consistent with the present invention might employ techniques to process ambiguous requests. For example, if the request is for “roses”, there might be a specific (exactly matching) search result for Rose's restaurant. However, there may be additional results for florists who sell roses (unspecific request). One technique might be to provide the matching result to the user first, followed by sponsored ads relating to the unspecific category “roses”, followed by the audio documents representing the search results for the unspecific category “roses”.

An alternative to providing a serial list of audio documents to the requesting user would be to employ an interactive voice response system. In such embodiments consistent with the present invention, the voice response system could be used to ask the requesting user whether the request (e.g., roses) is specific (e.g., for the restaurant) or unspecific (e.g., for a florist), or could be used to interact with the user after each audio document is presented to the user, to see if the user wants more responses, wants to be connected to the owner of the listing, wants additional information about the listing, wants to skip the listing, wants to replay the listing, etc.

An exact match with an audio document might mean an exact match with a component of the audio document. For example, an audio document might include a business name, city and telephone number. If the request includes the exact business name, it may be considered to match such an audio document exactly, even if the request does not include all of the components of the audio document.

Evidence of user intent might be gleaned from user responses to assist in the determination of whether the request is specific or not. For example, consider a user not responding to (or skipping) the first few presented audio document listings. This might be considered as evidence tending to indicate that the request was unspecific, in which case appropriate ads might then be served.

In at least some embodiments consistent with the present invention, a serial ad can be skipped in response to a “skip ad” user input. In at least some embodiments consistent with the present invention, a serial ad can be replayed in response to a “replay ad” user input.

In at least some embodiments consistent with the present invention, the list of unspecific categories can be updated either with new information from advertisers, or based on experience (history) with similar user requests.

In at least some embodiments consistent with the present invention, the list of unspecific categories can be location specific, or the location information may be combined with category listings.

It should be understood that more diverse search results can imply a more general request, while less diverse search results can imply a more specific request. In at least some embodiments consistent with the present invention, this analysis might be done on a per request basis. Further, more diverse search result selections by various users over time for the same request can imply a more general request, while less diverse search result selections over time can imply a more specific request. This analysis can be done by analyzing historical selections for given requests.

To ensure the high relevance of the ad, initially the ads themselves might be for connections to businesses like those the caller could reach with a specific business request. Over time the ad selection and the decision of whether to play the ad might also incorporate an expected likelihood of the caller selecting the ad, given previous callers' responses.

Ads with a serial (temporal) characteristic include audio ads, video ads, animation ads, etc.

The source of location information may include one or more of client device area code, client device cell/base station, GPS, express user entry, etc.

User input may be via a microphone, but the present invention is not limited to this. User input of request information may be via other input means.

### EXAMPLES OF OPERATIONS

Examples of operations in an exemplary embodiment consistent with the present invention are now described.

### Scenario 1: Unspecific Request

system: what city?

caller: lincoln Nebr.

system: what listing?

caller: pizza

system: sponsored link

pizza hut on third street

results in lincoln

dominos pizza on oak drive

old chicago on seventh street

caller: connect me

system: old chicago, dialing . . . (ring)

### Scenario 2: Specific Request

system: what city?

caller: lincoln Nebr.

system: what listing?

caller: joe's pizzeria

system: results in lincoln Nebr.

joe's pizzeria on third street

caller: connect me

system: joe's pizzeria, dialing . . . (ring)

In the foregoing scenarios, ads are only potentially played when the caller asks for an unspecific category search (pizza), and not for specific listings (joe's pizzeria).

### CONCLUSIONS

As can be appreciated from the foregoing, embodiments consistent with the present invention can be used to provide useful serial ads, such as ads for voice local search requests, which will benefit both the advertisers and the users of the service.

What is claimed is:

1. A computer-implemented method comprising:
a) accepting request information;
b) determining whether the request is for an unspecific business using the accepted request information;
c) if it is determined that the request is for an unspecific business, generating a responsive message including a first number of serial ads; and
d) if it is not determined that the request is for an unspecific business, generating a responsive message including a second number of serial ads, wherein the second number is less than the first number.

2. The computer-implemented method of claim 1 wherein the second number is zero.

3. The computer-implemented method of claim 2 wherein the first number is one.

4. The computer-implemented method of claim 1 further comprising:
e) transmitting the responsive message to a device associated with the request.

5. The computer-implemented method of claim 4 wherein the device sourced the request.

6. The computer-implemented method of claim 4 further comprising:
f) assessing a per-impression charge to advertisers of the serial ads.

7. The computer-implemented method of claim 4 further comprising:
f) accepting a request to establish a call from the device to an advertiser associated with at least one of the ads; and
g) assessing a per-conversion charge to the advertiser.

8. The computer-implemented method of claim 1 wherein the act of determining whether the request is for an unspecific business using the accepted request information includes matching the request information with entries on a list of unspecific business requests.

9. The computer-implemented method of claim 1 wherein the request information induces location information, and
wherein the act of determining whether the request is for an unspecific business using the accepted request information includes matching the request information with entries on a list of unspecific business requests entries on one of a plurality of location-specific lists of unspecific business requests.

10. The computer-implemented method of claim 1 wherein the act of determining whether the request is for an unspecific business using the accepted request information includes determining whether the number of identified listings in response to the request exceeds a predetermined number.

11. The computer-implemented method of claim 10 wherein the act of determining whether the request is for an unspecific business using the accepted request information further includes determining whether the request exactly matches one of the identified listings.

12. The computer-implemented method of claim 10 wherein the predetermined number is dependent on the geographic location of the requested information.

13. The computer-implemented method of claim 1 wherein the act of determining whether the request is for an unspecific business using the accepted request information includes determining audio documents relevant to the request, and determining a measurement of diversity of the determined audio documents, wherein if the measure of diversity is greater than a predetermined value, the request is determined to be unspecific.

14. The computer-implemented method of claim 1 wherein the act of determining whether the request is for an unspecific business using the accepted request information includes determining whether an audio document matches the request exactly, wherein if an audio document matches the request exactly, the request is determined to not be unspecific.

15. The computer-implemented method of claim 1 wherein the act of determining whether the request is for an unspecific business using the accepted request information includes determining whether only one audio document matches the request exactly, wherein if only one audio document matches the request exactly, the request is determined to not be unspecific.

16. Apparatus for serving an advertisement, the apparatus comprising:
a) an input for accepting request information;
b) means for determining whether the request is for an unspecific business using the accepted request information;
c) means for generating a responsive message including a first number of serial ads if it is determined that the request is for an unspecific business and
d) means for generating a responsive message including a second number of serial ads, wherein the second number is less than the first number, if it is not determined that the request is for an unspecific business.

17. The apparatus of claim 16 wherein the second number is zero.

18. The apparatus of claim 17 wherein the first number is one.

19. The apparatus of claim 16 further comprising:
e) means for transmitting the responsive message to a device associated with the request.

20. A computer-implemented method comprising:
a) accepting evidence of a user information need;
b) determining whether the user information need is for an unspecific business using the accepted evidence;
c) if it is determined that the user information need is for an unspecific business, generating a responsive message including a first number of serial ads; and
d) if it is not determined that the user information need is for an unspecific business, generating a responsive message including a second number of serial ads, wherein the second number is less than the first number.

21. The computer-implemented method of claim 20 wherein the second number is zero.

22. The computer-implemented method of claim 21 wherein the first number is one.
